(19) United States
(12) Patent Application Publication
(10) Pub. No.: US 2004/0175508 A1
(43) Pub. Date: Sep. 9, 2004

(54) Carrying method, carrying apparatus, coating method and coating material manufacturing method

(75) Inventor: Hideki Tanaka, Chuo-ku (JP)

Correspondence Address: DARBY & DARBY P.C., P. O. BOX 5257, NEW YORK, NY, 10150-5257, US

(73) Assignee: TDK Corporation, Tokyo (JP)

(21) Appl. No.: 10/792,520

(22) Filed: Mar. 2, 2004

(30) Foreign Application Priority Data
Mar. 6, 2003 (JP) 2003-060335

(51) Int. Cl. B05D 1/28; B05D 3/04

(52) U.S. Cl. 427/428.1

(57) ABSTRACT

Disclosed are carrying method and a carrying apparatus capable of carrying a flexible member to be carried in a way that flattens it. Further disclosed are a coating method of uniformly stably coating the thus flattened flexible member as a flexible support member with a coating liquid and a manufacturing method of manufacturing a coating material having uniform coating layer thickness by this coating method. In the carrying method and the carrying apparatus, a web is corrugated by deforming the web in a widthwise direction, a first guide roll disposed downstream thereof stretches the corrugation and thus corrects the web, thereby carrying the web in a flattened state. In the coating method and the coating material manufacturing method, downstream of the first guide roll, the corrugation is corrected, and the flat web is coated with a coating liquid.

### INCORPORATION BY REFERENCE

The present application claims priority under 35 U.S.C. §119 to Japanese Patent Application No. 2003-060335 filed on Mar. 6, 2003. The content of the application is incorporated herein by reference in its entirety.

### BACKGROUND OF THE INVENTION

1. Field of the Invention

The present invention relates to a carrying method and a carrying apparatus for carrying a web-shaped flexible member to be carried in a way that flattens the flexible member in the case of consecutively the flexible member by use of a carrying means such as a guide roll, etc., and further to a coating method of uniformly stably coating a coating liquid over the flexible member as a flexible support member after flattening the same member and to a manufacturing method of manufacturing a coating material by this coating method.

2. Description of the Prior Art

On the occasion of manufacturing a coating type of magnetic recording medium, a variety of method such as a roll coating method, a gravure coating method, a doctor coating method, and the like have hitherto been utilized as methods of coating the web-shaped flexible support member with a coating liquid. An emphasis is, however, put on an extrusion coating method capable of coating the flexible support member directly with the coating liquid without being exposed to the air with a small loss of the coating and thereby capable of exhibiting an excellent coating stability.

The extrusion coating method is that the web as a coated material is coated with a coating liquid extruded from a slit portion by controlling layer thickness to predetermined layer thickness in a way that pushes a front edge surface (disposed upstream in a support member carrying direction) and a back edge surface (disposed downstream in the support member carrying direction) of an extrusion coating head against the web so as to apply a predetermined tension to the web between carrying means such as support rolls, etc..

In the extrusion coating method described above, a corrugation and crinkling are easy to occur on the web due to a tension in a longitudinal direction when carrying the web, and might, if occurred, cause stripe-shaped or intermittent fluctuations in thickness. The method of carrying the web as the coated material is important for obviating those problems.

As a means for preventing an influence of the corrugation on the coating portion of the web, generally a backup roll is installed in a way that faces an extrusion coating device so as to interpose the web therebetween. According to this method, however, the coating thickness is determined based on a distance between the extrusion coating device and the backup roll, and hence there rise, as a matter of course, a working accuracy of the backup roll and also required levels of vibrations and of a deflection accuracy as well. It is quite difficult to form especially a thin film of which coating layer thickness after being dried is equal to or smaller than 1 μm.

Under such circumstances, Japanese Patent Application Publication No.2578631 and Japanese Patent Application Laid-Open Publication No.9-141173 disclose means for uniformizing a widthwise tension of the web at a coating portion. Further, Japanese Patent Application Laid-Open Publication No.11-128822 discloses a method of effecting the coating by pushing a tension adjusting means against the whole web in order to uniformize the tension for correcting a local stretch and deformation of the web, and correcting a resultantly deformed portion by an ingress guide roll at a coating portion.

It is, however, more important to apply a force of pulling the web in crosswise directions at the coating portion than to uniformize the widthwise tension in order to ameliorate the corrugation cased by carrying the web-shaped support member and to restrain an occurrence of scatter in coating. A corrugation correcting mechanism based on the principle described above is disclosed in Japanese Patent Application Laid-Open Publication No.5-62182. This is a method of pushing both of edges of the web in the process of being carried, with a pinch roller so as to apply a crosswise force by use of guide rolls disposed in front and in rear of the coating portion. According to this method, however, there arises a problem, wherein an extremely strong force is applied to the web, and therefore, if the support member is thin, the adjustment is difficult.

### SUMMARY OF THE INVENTION

It is a primary object of the present invention to provide a carrying method and a carrying apparatus capable of a flexible member to be carried by setting it in a flattened state especially in a case where the flexible member is thin.

It is another object of the present invention to provide a coating method of uniformly stably coating the thus-flattened flexible member as a flexible support member with a coating liquid, and a manufacturing method of manufacturing a coating material having uniform coating layer thickness owing to this coating method.

A carrying method in an embodiment is a method of carrying a flexible member to be carried by carrying means including guide rolls, comprising causing a recoverable deformation by deforming the flexible member in a widthwise direction, and correcting the flexible member by stretching the recoverable deformation thereof by a first guide roll disposed downstream of the carrying means and carrying the flexible member in a flattened state.

According to this carrying method, the deformation such as the recoverable corrugation, etc. is caused by deforming the flexible member in the widthwise direction thereof on the upstream side of the first guide roll, and is corrected by its being stretched as the flexible member passes through the first guide roll. It is therefore correct the so-called intentionally formed recoverable deformation, i.e., the whole including the intentionally formed recoverable deformation. With this contrivance, even if the flexible member is thin, the flexible member can be carried in the flattened state on the downstream side of the first guide roll.

Another carrying method according to the embodiment is a method of carrying a flexible member to be carried by carrying means including guide rolls, comprising causing a recoverable deformation so that a tension at both of edges of the flexible member in a widthwise direction is larger than a tension at a central portion, and correcting the flexible member by stretching the recoverable deformation thereof by a first guide roll disposed downstream thereof, and carrying the flexible member in a flattened state. This contrivance enables the flexible member to be carried in the flattened state downstream of the first guide roll.

Still another carrying method according to the embodiment is a method of carrying a flexible member to be carried by carrying means including guide rolls, comprising causing a recoverable deformation so that a traveling path at both of edges of the flexible member in a widthwise direction is longer than a traveling path at a central portion, and correcting the flexible member by stretching the recoverable deformation thereof by a first guide roll disposed downstream thereof, and carrying the flexible member in a flattened state. This contrivance similarly enables the flexible member to be carried in the flattened state downstream of the first guide roll.

According to the respective carrying methods, the deformation such as the recoverable corrugation, etc., can be caused by deforming the flexible member in such a direction as to narrow down a width thereof. Further, the deformation such as the recoverable corrugation, etc., can be caused by pushing up or down the edges in the vicinities of both of edges of the flexible member.

Further, a second guide roll is disposed upstream of the first guide roll, and the deformation such as the recoverable deformation can be caused between the first guide roll and the second guide roll. With this contrivance, there can be set in a state where a fixed tension is applied between the first guide roll and the second guide roll, whereby the deformation such as the recoverable corrugation, etc. can be effectively caused. Moreover, it is preferable that there is no necessity of using a special backup means, and the construction is simplified.

Preferably, the flexible member is carried so as to be wound over a predetermined range on a peripheral surface of the first guide roll. According to this contrivance, when passing through the first guide roll, the flexible member comes into a contact with the peripheral surface thereof, thereby effectively applying a widthwise stretching force to the flexible member.

A carrying apparatus according to the embodiment is an apparatus for carrying a flexible member to be carried by carrying means including guide rolls, comprising deforming means for causing a recoverable deformation by deforming the flexible member in a widthwise direction, and a first guide roll disposed downstream of the deforming means, wherein the flexible member is corrected by stretching the recoverable deformation thereof by the first guide roll, and is carried in a flattened state. The carrying methods described above can be executed by this carrying a aratus.

In this case, the deforming means can cause the recoverable deformation by deforming the flexible member in such a direction as to narrow down a width thereof.

Moreover, the deforming means can cause the recoverable deformation by pushing up or down the edges of the flexible member in the vicinities of the two edges of the flexible member.

Still further, a second guide roll is disposed upstream of the first guide roll, and the deforming means is disposed in a carrying section between the first guide roll and the second guide roll.

Yet further, the flexible member is carried so as to be wound over a predetermined range on a peripheral surface of the first guide roll.

A coating method according to the embodiment is a method of coating a flexible support member with a coating liquid by coating means disposed downstream of a first guide roll while carrying the flexible member as the flexible support member by the carrying method or by the carrying apparatus described above.

According to this coating method, the coating liquid can be coated over the flexible support member coming to the flattened state where there is no deformation such as the recoverable corrugation, etc. by making the flexible support member pass through the first guide roll. It is therefore feasible to perform the uniform and stable coating, effectively prevent a scatter in coating and obtain uniform coating layer thickness.

In this case, a third guide roll is disposed downstream of the coating means, and the coating means can coat the flexible support member with the coating liquid in a state of applying a predetermined tension by an extrusion coating method between the first guide roll and the third guide roll. This contrivance enables the coating liquid to be coated over the flexible support member to which the predetermined tension is applied by use of the extrusion coating method.

A coating material manufacturing method according to the embodiment is a method of manufacturing a coating material by coating the flexible member as the flexible support member with the coating liquid by the coating method described above. According to this coating material manufacturing method involves the use of the coating method described above is therefore capable of manufacturing the coating material having the uniform coating layer thickness.

### BRIEF DESCRIPTION OF THE DRAWINGS

FIG. 1A is a schematic sectional view of a carrying apparatus in which a coating means is disposed, showing an embodiment;

FIG. 1B is a partial enlarged view thereof;

FIG. 2 is a schematic plan view of the carrying apparatus in FIG. 1;

FIG. 3A is a cross-sectional view along line A-A′ in FIG. 2 showing a positional relationship between a web and rolls of a web deforming;

FIG. 3B is a cross-sectional view along line A-A′ in FIG. 2 showing a state of pushing down the two edges;

FIG. 4 is a view of the carrying apparatus in FIG. 1A as viewed in a downward direction perpendicular to a surface of a support member; and

FIG. 5 is a plan view showing a part of an example of a specific mechanism of the web deforming device in FIG. 1A.

### DETAILED DESCRIPTION OF THE PREFERRED EMBODIMENTS

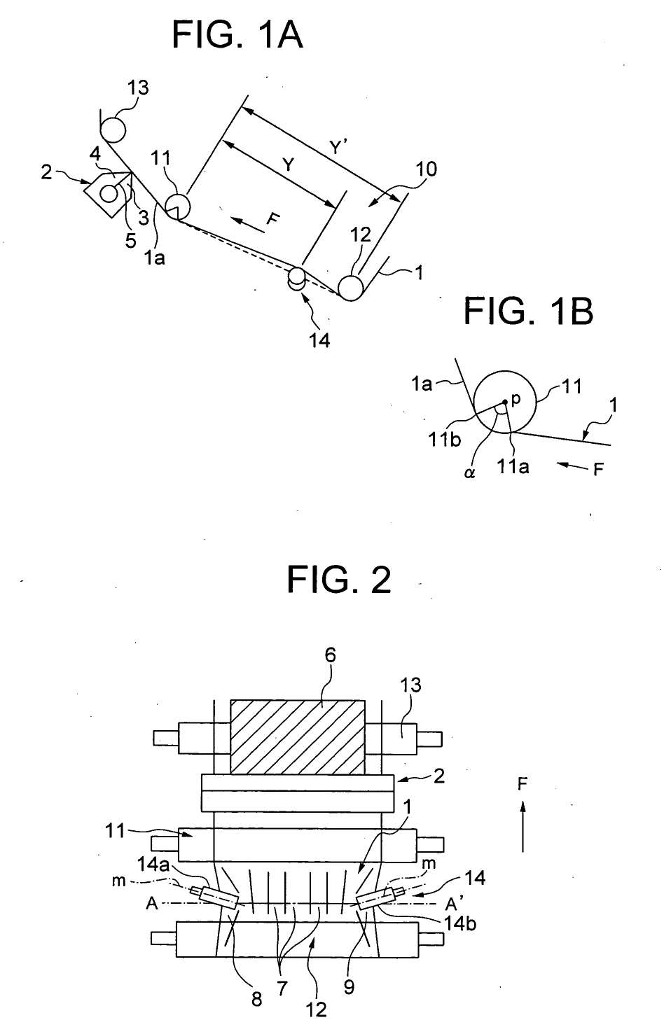

Embodiments of the present invention will hereinafter be described with reference to the accompanying drawings. FIG. 1A is a schematic sectional view showing a carrying apparatus provided with a coating means in the present embodiment. FIG. 1B is a partial enlarged view thereof. FIG. 2 is a schematic plan view of the carrying apparatus in FIG. 1A as viewed from the left side in FIG. 1A.

As illustrated in FIGS. 1A and 2, a carrying apparatus 10 carries a film-shaped flexible support member (which will hereinafter be termed a “web”) 1 as a carried member from a feeding unit (not shown) at a predetermined moving speed in order to coat the surface thereof with a coating liquid, coats its surface with the coating liquid by use of a coating means at a coating unit after passing through a plurality of guide rolls, and carries the web 1 to a drying unit (unillustrated).

The carrying apparatus 10 includes first, second and third guide rolls 11, 12, 13, each taking a cylindrical shape, for consecutively carrying the web 1 in a direction F in FIG. 1A while being rotated by a rotary mechanism (unillustrated) constructed of a motor, etc..

A web deforming device 14 defined as a deforming means for causing a recoverable deformation such as corrugation by deforming the web 1 in a widthwise direction, is disposed between the first guide roll 11 and the second guide roll 12 disposed upstream. Further, a coating device 2 defined as a coating means for coating a surface 1a of the web 1 with the coating liquid, is disposed between the first guide roll 11 and the third guide roll 13 disposed downstream.

Moreover, as shown in FIG. 1B, the web 1 is wound on the first guide roll 11 during the carry of the web 1. The web 1 is brought into a contact with the first guide roll 11 at a point 11a on the upstream side and at a point 11b on the downstream side. A central angle a made by the contact points 11a and 11b at a center p of the first guide roll 11 is set within a range of a predetermined angle, and the web 1 is kept contact over a predetermined range with a peripheral surface of the first guide roll 11.

The coating device 2 is based on an extrusion coating method and includes a front edge 3 disposed upstream, a back edge 4 disposed downstream and a slit portion 5 provided between the front edge 3 and the back edge 3, whereby the coating liquid is extruded from the slit portion 5. The coating device 2 performs coating in a way that controls layer thickness to predetermined thickness by changing an interval between the surface of the back edge 4 and the web 1 in accordance with a change in extrusion quantity of the coating liquid.

Next, the web deforming device 14 includes, as shown in FIG. 2, a pair of rolls 14a, 14b disposed respectively at edges 8, 9 of the web 1 in the widthwise direction. The rolls 14a, 14b are composed rotatably of a metal and are, as shown in FIG. 2, so disposed as to push up the edges 8, 9 of the web 1.

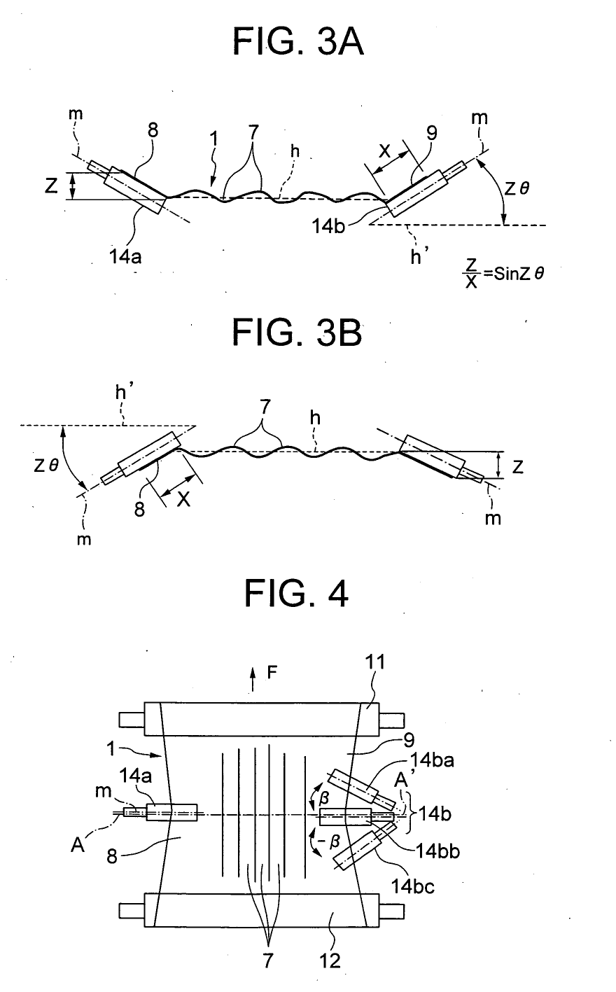

FIGS. 3A and 3B are views showing a positional relationship between the web 1 and the rolls 14a, 14b of the web deforming device 14 as viewed in section in the vicinity of the line A-A′ in FIG. 2, and showing a corrugated state of the web 1 corrugated by the rolls. FIG. 4 is an explanatory view of a deflection angle f of each of the rolls 14a, 14b, showing a part of the carrying apparatus in FIG. 1A as viewed in a downward direction perpendicular to the surface of the support member.

A central line m of each of the rolls 14a, 14b is, on the plane as shown in FIG. 4, slightly inclined at the deflection angle β (a position 14ba of the roller 14b in FIG. 4), for example, on the downstream side from the line A-A′ extending in the widthwise directions so as to be orthogonal to a longitudinal direction (the carrying direction F) of the web 1. Similarly, the central line m can be also inclined at a deflection angle −β (a roll position 14bc in FIG. 4) on the upstream side.

In FIGS. 3A and 3B, the web 1 is carried in the direction (the carrying direction F) perpendicular to the rear surface of the sheet surface. As shown in FIG. 3A, the web 1 is so pushed up as to be folded in the vicinities of the two edges 8, 9 by the rolls 14a, 14b at a push-up angle Zθ upwards in FIG. 3A on the basis of a horizontal line h (a broken line h′ is parallel to the horizontal line h) in a non-corrugated state drawn by a broken line in vertical section in the widthwise direction (the line A-A′) thereof. At this time, the web 1 comes into contact over a contact width X with the peripheral surfaces of the rolls 14a, 14b in the longitudinal direction thereof, at which time the rolls 14a, 14b are kept contact with the web 1 as positioned with an extrusion quantity Z while being inclined at the angle z e. The extrusion quantity Z is expressed by a distance in the direction perpendicular to the horizontal line h and is therefore given by Z=X sin Zθ.

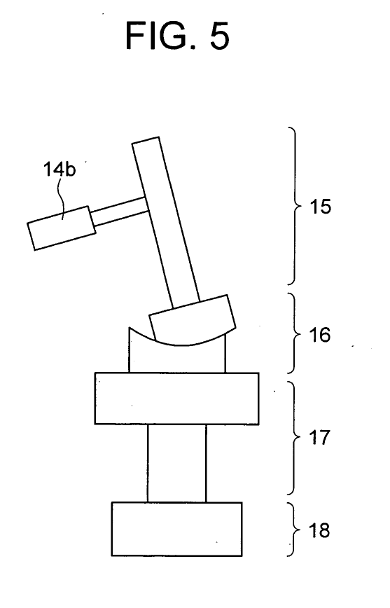

FIG. 5 illustrates a specific configuration of the web deforming device 14, wherein the web deforming device 14 is constructed by combining an x-y stage 17 with a z stage 15 and further combining a rotary stage 18 with an inclined stage 16. The angle β and the angle Zθ of the rolls 14a, 14b in FIGS. 2 through 4 can be finely adjusted by a mechanism as shown in FIG. 5.

The thus constructed carrying apparatus 10 will be described. The web 1 is carried at a predetermined moving speed from the feeding unit (not shown), and reaches the coating device 2 via the second guide roll 12 and the first guide roll 11. At this time, between the second guide roll 12 and the first guide roll 11, as shown in FIG. 3A, the web 1 is pushed up by the rolls 14a, 14b of the web deforming device 14 in the vicinities of the two edges 8, 9 thereof. As viewed from the plane in FIG. 2, the web 1 is carried in a state where the two edges 8, 9 thereof are stretched, and deforms in such a detection that a width between the two edges 8 and 9 is narrowed down, with the result that a multiplicity of larger corrugations 7 than when being normally carried, as shown in FIG. 3A, appear mainly in the vicinity of the central portion of the web 1 other than the deformed portions. In this case, a tensile force of each of the edges 8, 9 of the web 1 is larger than a tensile force in the vicinity of the central portion of the web 1. Further, a carry route for the two edges 8, 9 of the web 1 is longer than a carry route in the vicinity of the central portion of the web 1.

Next, the web 1 is carried via the first guide roll 11 to the coating device 2 while being wound, at the central angle α as shown in FIG. 1B, on the peripheral surface of the first guide roll 11. During this passage, the web 1 is abruptly stretched in the widthwise direction, and at the same time, it is considered, bending stresses occur in the two edges 8, 9 of the web 1 due to unevenness in the tensile force in an interval (having a distance Y in FIG. 1A) between the rolls 14a, 14b and the first guide roll 11. A tensile force for pulling the web 1 in the widthwise direction during the passage through the first guide roll 11 is generated by a force (an offset force) by which the web 1 is abruptly stretched in the widthwise direction and by the bending stresses occurred in the two edges 8. This tensile force corrects the corrugation 7 of the web 1 and also the corrugations smaller than the corrugation 7, whereby the whole web 1, it is considered, becomes flat downstream of the first guide roll 11.

The Web 1 comes to the flattened state with the corrugations corrected and to the state where a fixed tension is applied, and the coating liquid is coated over a coated area 6 (indicated by hatching in FIG. 2) of the surface 1a by the coating device 2. Thereafter, the web 1 is carried via the third guide roll 13 to the drying unit (unillustrated).

In this case, in spite of providing none of particular backup means in the coating device 2 for the web 1, the coating liquid is coated over the web 1 in the state where the web 1 has no corrugation and is flat with the predetermined tension, and hence the coating layer is stably uniformly formed. If the web surface is corrugated, the corrugations appear directly as a scatter in coating. According to this embodiment, however, it is possible to prevent the coating from being scattered.

The rolls 14a, 14b of the web deforming device 14 may push down the two edges 8, 9 of the web 1 as shown in FIG. 3B. The angle Zθ, a contact width X and a push-down quantity Z in this case can be defined in the same way as in the case of FIG. 3A. Further, the web is deformed with corrugations in such a direction that the width thereof is narrowed down by pushing up one edge thereof and pushing down the other edge, whereby the same effect can be obtained.

Moreover, the rolls 14a, 14b may involve using materials such as urethane rubber, etc. other than the metals, and the effect remain unchanged even if not rotated, however, it is preferable that the rolls are rotated in consideration of a damage to the web.

Further, the material of the web 1 in this embodiment is mainly a plastic film such as a polyolefin film, polyester film, a polyamide film, etc., wherein the film is as thin as 15 μm or smaller in thickness in the majority of cases. Moreover, the web composed of one of these materials may be subjected to pre-processing such as a corona discharge process, etc., and there may be an original sheet over which an undercoat layer and a back-coat layer have previously been applied.

Further, when making the rolls 14a, 14b abut on the two edges 8, 9 of the web 1 and deforming the web 1 in the narrow-down direction of the width thereof, if the web 1 is thin, it is required that a caution be given to the corrugation caused by folding. This is a phenomenon, wherein the web 1, if the web 1 is pushed up or down at a highly acute angle, is unable to follow up with an abrupt change and is consequently folded. If the web is folded, a preferable coating property can not be acquired, and hence the angle Zθ and extrusion (push-down) quantity Z are required to be adjusted to values suited to a strength of the web.

Further, as shown in FIG. 3A, the contact width X becomes small when the angle Zθ is large but is large when the angle Zθ is small. If the deflection angle β of the roll (the roll 14b in FIG. 4) comes to a minus-side of the inclination towards the upstream side as from a zero-position 14bb to a position 14bc as shown in FIG. 4, a more conspicuous corrugation is formed at the central portion of the web 1. Whereas if towards a minus-side, the effect thereof decreases. Because of this tendency, it is desirable that the adjustment be made properly in accordance with a corrugation stretching condition as by the central angle α of the first guide roll.

Further, what can be given as a more important condition may be the carrying conditions such as the central angle α of the first guide roll 11, the distance between the first guide roll 11 and the second guide roll 12, the tension applied on the web, and the positional relationship (the distance Y) of the web deforming device 14. These conditions have optimal values depending on a type of the web and a degree of how much the corrugation is formed.

Generally, if the central angle α of the first guide roll 11 increases, this results in cutting the bending stress and the offset force by which the web is pulled in the widthwise direction. Therefore, the web deforming device 14 must move close to the first guide roll 11 (the distance Y is decreased), or more strict conditions must be set. Whereas if the central angle a decreases, the large corrugation formed by the web deforming device 14 exerts an influence directly on the vicinity of the coating device, and hence it is required that the web deforming device 14 be spaced away properly (the distance Y be increased). When the central angle α of the first guide roll 11 is, though not particularly limited, set equal to or smaller than 120 degrees and is preferably set within a range of 10 through 60 degrees, the effects of the present invention are easy to acquire. Further, if a distance Y′ between the guide roll 11 and the guide roll 12 changes, an optimal value of the distance Y also changes, and it is therefore necessary to determine an effective range of the central angle α in a way that takes these elements into account and to set a layout conforming with the coating conditions and with the corrugation stretching conditions as well.

Moreover, generally the web deforming device 14 is, as shown in the Figure, disposed away from the coating device and one guide roll in the section on the upstream side. In the case of being disposed away from the plurality of guide rolls, however, if the central angle α of the guide roll is small, the corrugation stretching effect can be acquired. If installed on the downstream side, however, the effect can not be confirmed.

Next, the detailed description will hereinafter be made by showing specific conditions by way of examples.

### EXAMPLES 1 TO 4 AND COMPARATIVE EXAMPLES 1 TO 4

The coating condition is that the coating material involves using a non-magnetic coating liquid composed mainly of iron oxide and exhibiting a viscosity of 20 cps (3000 sec⁻¹), wherein a corrugation-corrected state or a corrugation-uncorrected state is generated by use of the device (the rolls 14a, 14b are rotatable) as shown in FIGS, 1 through 5, the coating device 2 coats the coating liquid over the films (webs) that have a variety of thickness and are 280 mm in width by the extrusion method, and the coated material is wound up in roll after being dried.

Other conditions are as follows:

| | |
|---|---|
| Carrying speed of the support member | 100 (m/min) |
| Coating width | 270 (mm) |
| Coating length | 5,000 (m) |
| Coating layer thickness | 2 (μm) |
| after being dried | |
| Tension of support member (web) | 6 (kgf/base width, 58.8 N/base |
| | width) |

Further, the corrugation correcting condition is that the film is deformed in the widthwise direction by contracting it at the two edges of the film so as to push up the two edges of the film as shown in FIG. 3A. The specific conditions are given as below:

| | |
|---|---|
| Central angle α of the first | 15 (degrees) |
| guide roll | |
| Distance Y | 400 (mm) |
| Distance Y′ | 450 (mm) |
| Angle Zθ | 10 (degrees) |
| Contact width X | 70 (mm) |
| Extrusion quantity | 12 (mm) |
| Deflection angle β | −5 (degrees) |

Under the above conditions, the coating material is manufactured by way of examples 1 to 4 in a way that changes the film material and the thickness under the above conditions, and Table 1 shows results of the examples 1 to 4 together with results of the comparative examples 1 to 4 with no correction of the corrugation.

The following are judgment criteria in Table 1 and Table 2.

◯: Neither the corrugation nor crinkling can be visually confirmed when carrying the support member (just before coating), and the scatter in coating on the transmissive surface can not be confirmed. An X-ray layer thickness measurement is made, wherein a fluctuation of the layer thickness falls within 0.05 μm.

Δ: The corrugation and the crinkling are visually confirmed when carrying the support member (just before coating), however, the scatter in coating on the transmissive surface is within an allowable level. The X-ray layer thickness measurement is made, wherein the fluctuation of the layer thickness is larger than 0.05 μm but within 0.1 μm.

X: The corrugation and the crinkling are visually confirmed when carrying the support member (just before coating), and a large scatter in coating on the transmissive surface is confirmed. The X-ray layer thickness measurement is made, wherein the layer thickness fluctuates in excess of 0.1 μm.

TABLE 1

| | Film thickness (μm) | | | | | | | |
|---|---|---|---|---|---|---|---|---|
| | PET 9 | | PET 5.9 | | PEN 5.9 | | Polyamide 4 | |
| Corrugation | | Non- | | Non- | | Non- | | Non- |
| corrected | Corrugated | corrugated | Corrugated | corrugated | Corrugated | corrugated | Corrugated | corrugated |
| Example | Example 1 | Comparative | Example 2 | Comparative | Example 3 | Comparative | Example 4 | Comparative |
| Comparative | | example 1 | | example 2 | | example 3 | | example 4 |
| example | | | | | | | | |
| Judgment | ◯ | Δ | ◯ | X | ◯ | X | ◯ | X |

### EXAMPLE 5 AND COMPARATIVE EXAMPLE 5

Next, the respective process such as drying and mirror-finishing are executed under such a coating condition that the coating device 2 coats a non-magnetic coating liquid composed mainly of iron oxide and having a viscosity of 20 cps (3000 sec⁻¹) over a polyethylene terephthalate film that is 5.9 μm in thickness and 650 mm in width in a corrugation-corrected state or a corrugation-uncorrected state (in the same way as in the examples 1 to 4), and thereafter the film is wound up in roll.

| | |
|---|---|
| Carrying speed of the support member | 150 (m/min) |
| Coating width | 640 (mm) |
| Coating length | 5,000 (m) |
| Coating layer thickness | 2 (μm) |
| after being dried | |
| Tension of support member (web) | 10 (kgf/base width, 98 N/base |
| | width) |

The corrugation correcting condition is that the film is deformed in the widthwise direction by contracting it at the two edges of the film so as to push up the two edges of the film as shown in FIG. 3A. The specific conditions are given as below:

| | |
|---|---|
| Central angle α of the first | 45 (degrees) |
| guide roll | |
| Distance Y | 300 (mm) |
| Distance Y′ | 350 (mm) |
| Angle Zθ | 5 (degrees) |
| Contact width X | 90 (mm) |
| Extrusion quantity | 6 (mm) |
| Deflection angle β | −5 (degrees) |

Under the above conditions, the coating material is manufactured by way of the example 5, and Table 2 shows a result of the example 5 together with a result of the comparative example 5 with no correction of the corrugation.

TABLE 2

Example Comparative example

| | | Comparative |
|---|---|---|
| | Example 5 | example 5 |
| Corrugation | Provided | Non-provided |
| correcting device | | |
| Judgment | ◯ | X |

### EXAMPLE 6 AND COMPARATIVE EXAMPLE 6

Next, the processes such as drying, orientation and mirror-finishing are effected under such a coating condition that the coating device 2 coats a magnetic coating liquid containing a magnetic-powder and having a viscosity of 10 cps (3000 sec⁻¹) over a non-magnetic layer obtained by the same method as in the example 5 in a corrugated state or a non-corrugated state.

### EXAMPLE 7 AND COMPARATIVE EXAMPLE 7

Further, the processes such as drying and mirror-finishing are effected, a back-coat liquid containing carbon and having a viscosity of 3 cps (3000 sec⁻¹) is coated over a support member surface opposite to the side provided with the magnetic layer obtained by the same method as in the example 6 in a corrugated state or a non-corrugated state, and the film is wound up.

| | |
|---|---|
| Carrying speed of the support member | 200 (m/min) |
| Coating width | 650 (mm) |
| Coating length | 5,000 (m) |
| Magnetic layer thickness | 0.2 (μm) |
| after being dried | |
| Back-coat layer thickness | 0.5 (μm) |
| after being dried | |
| Tension of support member (web) | 10 (kgf/base width, 98 N/base |
| | width) |

Further, as the corrugation correcting condition, a deformed state is generated by contracting the film in the widthwise direction so as to push down the two edges of the film as shown in FIG. 3B when forming the magnetic layer. Other conditions are the same as in the example 5. Further, a deformed state is generated by contracting the film in the widthwise direction so as to push up the two edges of the film as shown in FIG. 3A when forming the back-coat layer. Other conditions are the same as in the example 5. Table 3 shows evaluation results of the scatters in coating in the examples 6 and 7 together with results in the comparative examples 6 and 7.

TABLE 3

| Coating | |
|---|---|
| Coating of magnetic | Coating of back-coat |
| coating liquid | coating liquid |

| | | | | |
|---|---|---|---|---|
| Corrugation | Provided | Non-provided | Provided | Non-provided |
| correcting | | | | |
| device | | | | |
| Example | Example 6 | Comparative | Example 7 | Comparative |
| Comparative | | example 6 | | example 7 |
| example | | | | |
| Judgment | ◯ | X | ◯ | X |

The judgment criteria in Table 3 are as follows:

The confirmation of the back-coat layer has been made after removing the non-magnetic layer and the magnetic layer by a solvent.

◯: Almost no scatter in coating on the transmissive surface is confirmed.

X: A large scatter in coating on the transmissive surface is confirmed.

As exemplified in the examples given above, it can be understood that the preferable coating can be actualized by obtaining the flattened state where the corrugations on the coating portion of the film are eliminated irrespective of the type and the width of the film. It can be also understood that the preferable coating can be actualized by eliminating the corrugations on the coating portion irrespective of whether the type of the coating liquid is non-magnetic or magnetic and with every viscosity.

As discussed above, the present invention has been described by way of the embodiments, however, the present invention is not limited to those embodiments and can be modified in many forms within the scope of the technical idea of the present invention. For example, the carrying method and the carrying apparatus of the present invention are not confined to the case of carrying the flexible member for coating and can be, as a matter of course, applied to a case of carrying the flexible member with the corrugations corrected for other purposes.

According to the present embodiment, it is feasible to provide the carrying method and the carrying apparatus capable of carrying the flexible member in a way that bring this member into the flattened state, and the embodiment is effective especially in the case where the flexible member is thin.

Moreover, it is possible to provide the coating method of uniformly stably coating the coating liquid over the thus-flattened flexible member as the flexible support member, and the manufacturing method of manufacturing the coating material having the uniform coating layer thickness owing to this coating method.

What is claimed is:

1. A carrying method of carrying a flexible member to be carried by carrying means including guide rolls, comprising the steps of:
causing a recoverable deformation by deforming said flexible member in a widthwise direction; and
correcting said flexible member by stretching the recoverable deformation thereof by a first guide roll disposed downstream of said carrying means, and carrying said flexible member in a flattened state.

2. A carrying method of carrying a flexible member to be carried by carrying means including guide rolls, comprising the steps of:
causing a recoverable deformation so that a tension at both of edges of said flexible member in a widthwise direction is larger than a tension at a central portion; and
correcting said flexible member by stretching the recoverable deformation thereof by a first guide roll disposed downstream of said carrying means, and carrying said flexible member in a flattened state.

3. A carrying method of carrying a flexible member to be carried by carrying means including guide rolls, comprising the steps of:
causing a recoverable deformation so that a traveling path at both of edges of said flexible member in a widthwise direction is longer than a traveling path at a central portion; and
correcting said flexible member by stretching the recoverable deformation thereof by a first guide roll disposed downstream of said carrying means, and carrying said flexible member in a flattened state.

4. A carrying method according to claim 1, wherein the recoverable deformation is caused by deforming said flexible member in such a direction as to narrow down a width thereof.

5. A carrying method according to claim 1, wherein the recoverable deformation is caused by pushing up or down the edges of said flexible member in the vicinities of the two edges of said flexible member.

6. A carrying method according to claim 1, wherein a second guide roll is disposed upstream of said first guide roll, and
the recoverable deformation is caused between said first guide roll and said second guide roll.

7. A carrying method according to claim 1, wherein said flexible member is carried so as to be wound over a predetermined range on a peripheral surface of said first guide roll.

8. A carrying apparatus for carrying a flexible member to be carried by carrying means including guide rolls, comprising:
deforming means for causing a recoverable deformation by deforming said flexible member in a widthwise direction; and
a first guide roll disposed downstream of said deforming means,
wherein said flexible member is corrected by stretching the recoverable deformation thereof by said first guide roll, and is carried in a flattened state.

9. A carrying apparatus according to claim 8 wherein said deforming means causes the recoverable deformation by deforming said flexible member in such a direction as to narrow down a width thereof.

10. A carrying apparatus according to claim 8, wherein said deforming means causes the recoverable deformation by pushing up or down the edges of said flexible member in the vicinities of the two edges of said flexible member.

11. A carrying apparatus according to claim 8 wherein a second guide roll is disposed upstream of said first guide roll, and
said deforming means is disposed in a carrying section between said first guide roll and said second guide roll.

12. A carrying apparatus according to claim 8, wherein said flexible member is carried so as to be wound over a predetermined range on a peripheral surface of said first guide roll.

13. A carrying apparatus according to claim 8 comprising:
a coating liquid by coating means disposed downstream of a first guide roll while carrying said flexible member as said flexible support member by said carrying method.

14. A carrying apparatus according to claim 13, wherein a third guide roll is disposed downstream of said coating means, and
said coating means coats the coating liquid over said flexible support member in a state of applying a predetermined tension by an extrusion coating method between said first guide roll and said third guide roll.

15. A coating material manufacturing method of manufacturing a coating material by coating the coating liquid over said flexible support member by said coating method according to claim 13.

16. A carrying method according to claim 2, wherein the recoverable deformation is caused by deforming said flexible member in such a direction as to narrow down a width thereof.

17. A carrying method according to claim 2, wherein the recoverable deformation is caused by pushing up or down the edges of said flexible member in the vicinities of the two edges of said flexible member.

18. A carrying method according to claim 2, wherein a second guide roll is disposed upstream of said first guide roll, and
the recoverable deformation is caused between said first guide roll and said second guide roll.

19. A carrying method according to claim 2, wherein said flexible member is carried so as to be wound over a predetermined range on a peripheral surface of said first guide roll.

20. A carrying method according to claim 3, wherein the recoverable deformation is caused by deforming said flexible member in such a direction as to narrow down a width thereof.

21. A carrying method according to claim 3, wherein the recoverable deformation is caused by pushing up or down the edges of said flexible member in the vicinities of the two edges of said flexible member.

22. A carrying method according to claim 3, wherein a second guide roll is disposed upstream of said first guide roll, and
the recoverable deformation is caused between said first guide roll and said second guide roll.

23. A carrying method according to claim 3, wherein said flexible member is carried so as to be wound over a predetermined range on a peripheral surface of said first guide roll.
